(19) United States
(12) Patent Application Publication
(10) Pub. No.: US 2006/0119081 A1
(43) Pub. Date: Jun. 8, 2006

(54) Device and a method for folding a gas bag

(75) Inventors: Manfred Heimberger, Waldaschaff (DE); Marko Herbig, Zittau (DE); Ulrich Gaiser, Mulfingen (DE); Lothar Orth, Aschaffenburg (DE); Markus Magoley, Aschaffenburg (DE); Dominik Schuetz, Waldaschaff (DE); Slawomir Zygmunciak, Czestochowa (PL)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/288,791

(22) Filed: Nov. 29, 2005

(30) Foreign Application Priority Data
Dec. 2, 2004 (DE) 10 2004 058 203.3
Mar. 21, 2005 (DE) 10 2005 013 010.0

(51) Int. Cl. B60R 21/217; B60R 21/237; B65B 63/04

(52) U.S. Cl. 280/728.2; 280/743.1; 53/429; 493/405

(57) ABSTRACT

A device for folding a gas bag (10) comprises a positioning means for the gas bag (10) with a tubular folding device (32). The positioning means positions the gas bag (10) such that upon an axial movement of the tubular folding device (32), the gas bag (10) is turned over the tubular folding device (32). A method of folding a gas bag (10) having an inflation opening, using a device of this type comprises the following steps:
positioning the tubular folding device (32) on the side of the gas bag (10) opposite the inflation opening;
axially displacing the tubular folding device (32) through the inflation opening, so that the gas bag (10) is turned over the tubular folding device (32); and
withdrawing the tubular folding device (32) from the inflation opening.

### TECHNICAL FIELD

The invention relates to a device and a method for folding a gas bag. The invention further relates to a method of assembling a gas bag module and a gas bag module assembled in accordance with this method.

### BACKGROUND OF THE INVENTION

Numerous methods are known for folding a gas bag, which are used during the positioning of a gas bag into a mounting of a gas bag module. Generally, during the assembly of the module, the gas bag is clamped with a gas bag holding plate or with a flange of the gas generator of the module by screws or rivets against a gas generator carrier. This requires manual work and additional expenditure of time, materials, tools and hence costs.

It is an object of the invention to enable an automated gas bag module assembly, in which in particular the gas bag folding and gas bag fastening can be embedded into the automated assembly process.

### BRIEF SUMMARY OF THE INVENTION

For this purpose, according to the invention, a device for folding a gas bag is provided. The device comprises a positioning means for the gas bag and a tubular folding device. The positioning means positions the gas bag such that upon an axial displacement of the tubular folding device, the gas bag is turned over the tubular folding device.

In a preferred embodiment of the device according to the invention, the tubular folding device includes an outer tube having several bores. The tubular folding device is adapted to be connected to a suction pump.

The invention further provides a method of folding a gas bag having an inflation opening. The method uses a device according to the invention and comprises the following steps:

positioning the tubular folding device on the side of the gas bag opposite the inflation opening;

axially displacing the tubular folding device through the inflation opening, so that the gas bag is turned over the tubular folding device and turned inside out; and

withdrawing the tubular folding device from the inflation opening.

In a preferred embodiment of the method according to the invention, prior to withdrawal of the tubular folding device, air present in the gas bag is sucked out, in particular through the tubular folding device.

The invention also provides for a method of assembling a gas bag module. The method comprises the step of folding the gas bag in accordance with the folding method according to the invention. The axial displacement of the tubular folding device causes the gas bag to be pushed through an opening into a mounting, preferably a gas generator carrier.

Finally, the invention also provides a gas bag module which is assembled in accordance with the assembly method according to the invention.

### BRIEF DESCRIPTION OF THE DRAWINGS

FIGS. 1 to 6 show various successive steps in the assembly of a gas bag module according to the invention;

FIGS. 7 and 8 show perspective views of the two opposite ends of a tubular folding device;

FIG. 9 shows a lateral sectional view of a gas bag module with an alternative gas bag fastening;

FIG. 10 shows a perspective view of the fastening ring used in the gas bag module of FIG. 9;

FIG. 11 shows a lateral sectional view of a gas bag module with a further alternative gas bag fastening;

FIG. 12 shows a perspective view of the fastening ring used in the gas bag module of FIG. 11;

FIG. 13 shows a lateral sectional view of a gas bag module, with the gas bag inflated, with an alternative arrangement of the limiting strap; and

FIG. 14 shows a top view onto a spread-out gas bag with an alternative design of the inflation opening.

### DETAILED DESCRIPTION OF THE PREFERRED EMBODIMENT

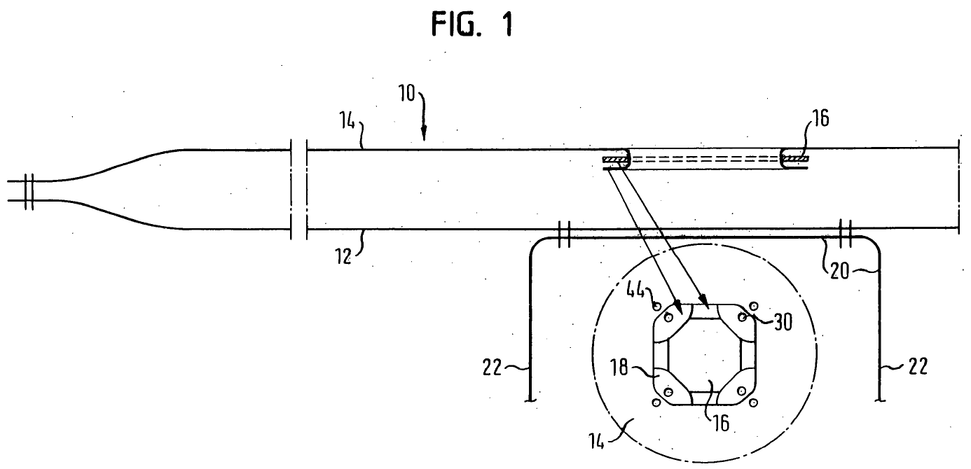

FIG. 1 shows a gas bag 10 which is formed from two fabric blanks 12, 14. The two fabric blanks 12, 14 are connected with each other at their edges by sewing, gluing or in some other manner. A sheet metal, plastic or wire part 16 was previously automatically arranged on one of the blanks. The part 16 corresponds to the later inflation opening contour of the gas bag. The shape of part 16 can be seen from the turned-down detail view of FIG. 1 (viewed from the interior of the gas bag 10). Through an automated sewing or gluing process and by the folding over of wings 18, the part 16 is fastened to the blank 14.

A limiting strap 20 can optionally be provided on the outer side of the other blank 12. The limiting strap 20 is both automatically cut to size and also arranged on the blank 12. The central section of the limiting strap 20 is sewn on or glued on, and the two ends 22 of the limiting strap 20 remain loose.

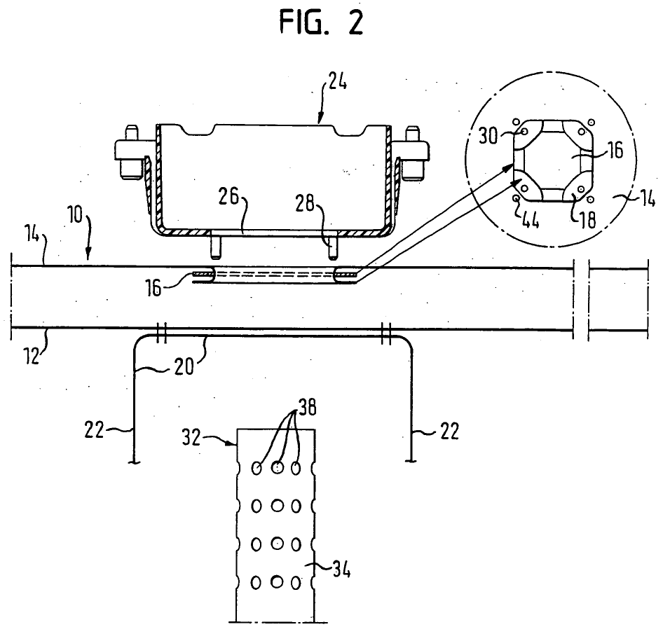

The gas bag 10 of FIG. 1 is conveyed by a conveyor belt to a folding station, at which a cup-shaped gas generator carrier 24 is provided. The gas bag 10, as shown in FIG. 2, is positioned so that the inflation opening of the gas bag 10 lies precisely opposite a corresponding opening 26 of the gas generator carrier 24. Plastic pins 28, which project from the gas generator carrier 24, engage into corresponding holes 30 of the gas bag 10 and of the part 16. On the other side of the gas bag 10, between the limiting strap ends 22, a tubular folding device 32 is aligned coaxially to the inflation opening and to the opening 26 in the gas generator carrier 24.

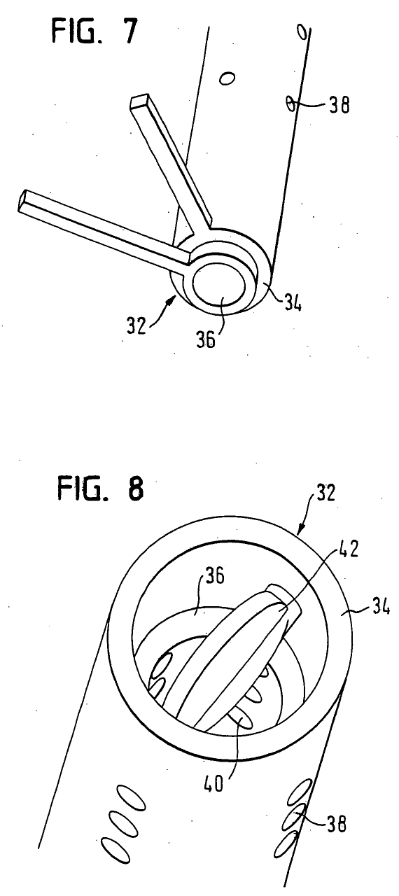

Details of the tubular folding device 32 can be seen in FIGS. 7 and 8. The device 32 consists of an outer tube 34 and an inner tube 36, which are both provided with a plurality of bores 38 and 40, respectively. In the illustrated example, the bores of the outer tube 34 and of the inner tube 36 are arranged in several axial rows and can be aligned to each other. The tubes 34, 36 are both rotatable and also axially displaceable relative to each other. Whereas the lower end of the tubular folding device 32 according to FIG. 2 is open (see FIG. 7), at the upper end a controllable flap 42 is provided (see FIG. 8), with which the tubular folding device 32 can be closed.

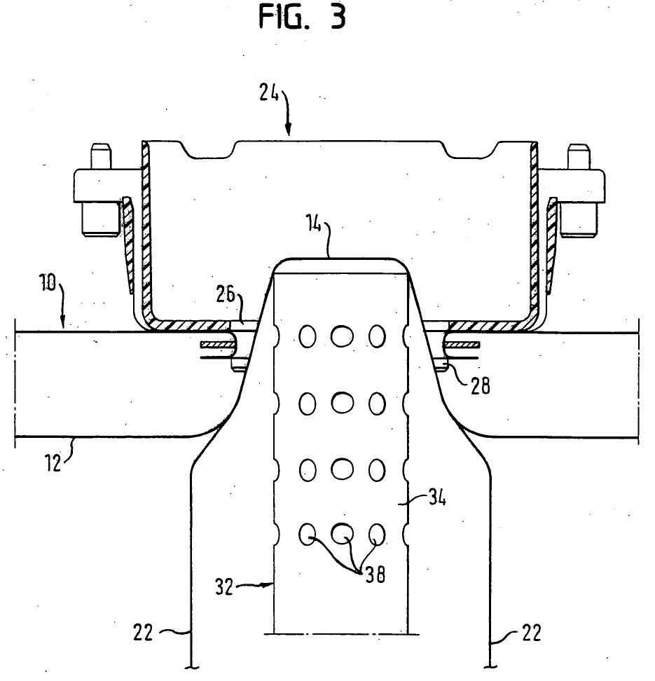

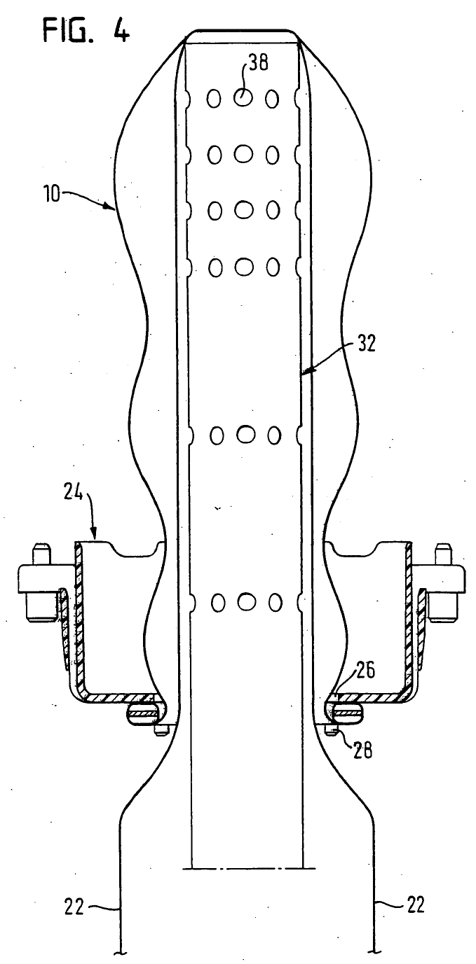

FIG. 3 shows how the gas bag 10 is pulled through the opening 26 into the gas generator carrier 24 by means of the tubular folding device 32 while it is turned inside out at the inflation opening. In the process, the holes 44 of the gas bag 10 still situated outside the inflation opening before the pushing-in of the tubular folding device 32, are automatically drawn over the pins 28 of the gas generator carrier 24, which pins 28 already engage into the holes 30. The tubular folding device 32 is moved upwards up to a limit which is produced through the vertical height (in relation to the illustration of FIG. 4) of the non-inflated gas bag 10 not restrained by the limiting strap 20. The blanks 12, 14 are then passed practically completely through the opening 26 in the gas generator carrier 24 (see FIG. 4). The loose ends 22 of the limiting strap 20, on the other hand, are longer than the displacement path of the tubular folding device 32, so that the ends 22 still project out from the opening 26.

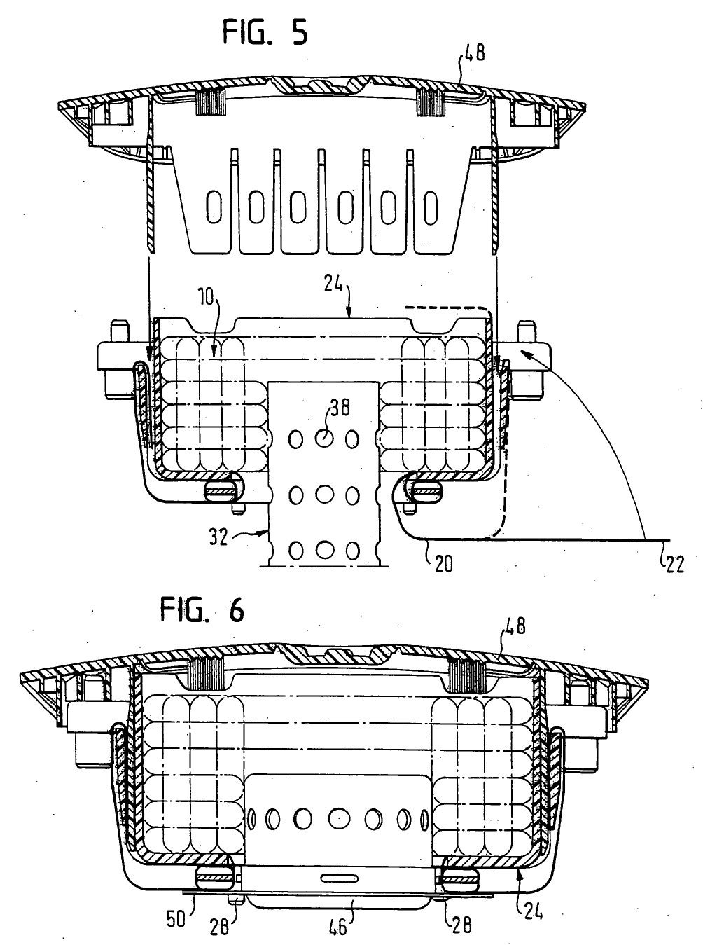

Whilst the tubular folding device 32 lies against the stop, all or part of the air present in the gas bag 10 is sucked off through the open lower end by means of a suction pump connected to the tubular folding device 32. The bores 40 of the inner tube 36 are aligned to the bores 38 of the outer tube 34 during the sucking out. Owing to the bores 38, 40 arranged in axial rows, a folding of the gas bag 10 occurs as in an umbrella. Through a defined turning and/or axial displacement of the two tubes 34, 36 and also through a defined controlling of the flap 42, the gas bag can be folded in a defined and reproducible manner into the free interior of the gas generator carrier 24, as is shown in FIG. 5, when the tubular folding device 32, which is still connected to the suction pump, is drawn out.

If necessary, the folding can take place in an axial extension of the side wall of the gas generator carrier 24 provided for this, and the folded gas bag 10 can be pressed down by means of a plate or the like adapted to the diameter of the gas generator carrier 24, in order to achieve the desired packing height and packing density of the gas bag package. In addition, the upper end of the tubular folding device 32 can serve as “space keeper” for the gas generator 46 which is to be inserted later.

The loose limiting strap ends 22 are drawn out up to a predetermined length with the tubular folding device 32 and are then fixed. This length of the limiting strap ends 22 determines the maximum axial extent of the gas bag 10 on its unfolding. The fixing can advantageously take place by clamping in the compound of the gas generator carrier 24 and a covering cap 48 placed thereon, so that an additional screwing, welding or the like can be dispensed with.

Finally, the gas generator 46 is inserted into the gas generator carrier 24, after the tubular folding device 32 has been removed (FIG. 6). The gas generator 46 has at the bottom a fastening flange 50 provided with bores, which is placed onto the pins 28. The protruding sections of the pins 28 are used for fastening the gas generator 46 by ultrasonic welding or hot calking (see right-hand pin 28 in FIG. 6), the gas bag 10 being securely clamped between the gas generator carrier 24 and the fastening flange 50 by means of the sheet metal, plastic or wire part 16. Furthermore, the outer contour of the part 16 is constructed so as to be larger than the through-bore 26 of the gas generator carrier 24, so that the base of the gas generator carrier 24 undertakes the function of a hitherto usual gas bag holding plate, and forces are passed on to the steering wheel and hence to the vehicle via known types of fastening such as snap-in or screw fastenings.

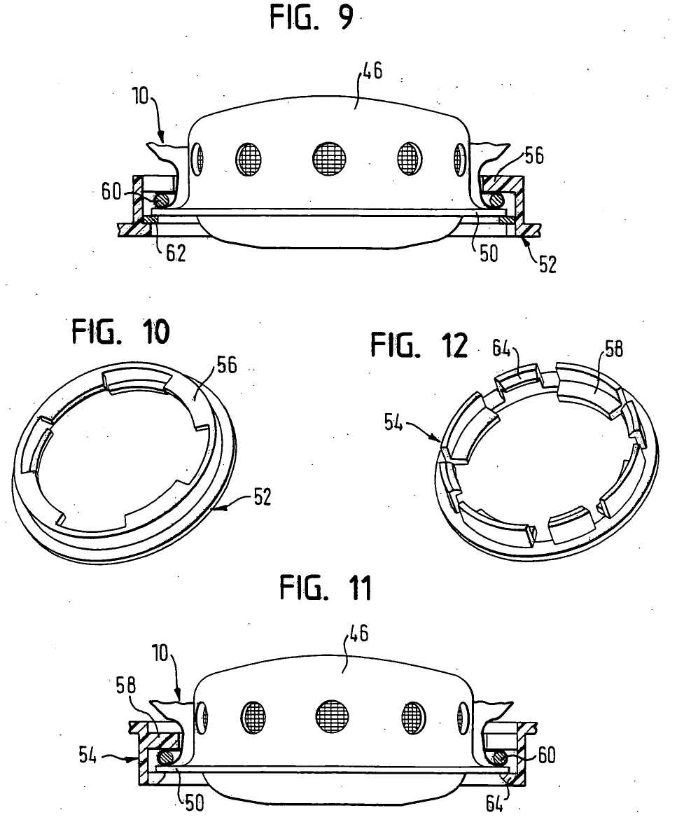

In FIGS. 9 and 11, two alternative types of fastening of the gas bag 10 and of the gas generator 46 are shown. In both cases, the gas bag 10 and the fastening flange 50 of the gas generator 46 are fastened by means of a fastening ring 52 and 54, respectively (see FIGS. 10 and 12). The fastening ring can be a component part of the gas generator carrier 24. The fastening ring forms a kind of shaft which is constricted towards the top by cross-pieces 56 and 58, respectively, of the fastening ring 52 and 54, respectively. In each of these embodiments, the gas bag 10 is wound around a wire ring 60 which is held between the cross-pieces 56 and 58 respectively, and the flange 50 of the gas generator 46. Towards the bottom, the shaft is constricted either by a securing ring 62 (FIG. 9) or by clips 64 (FIG. 11). Provision can also be made to fasten only the gas bag 10 or only the gas generator 46 in this manner.

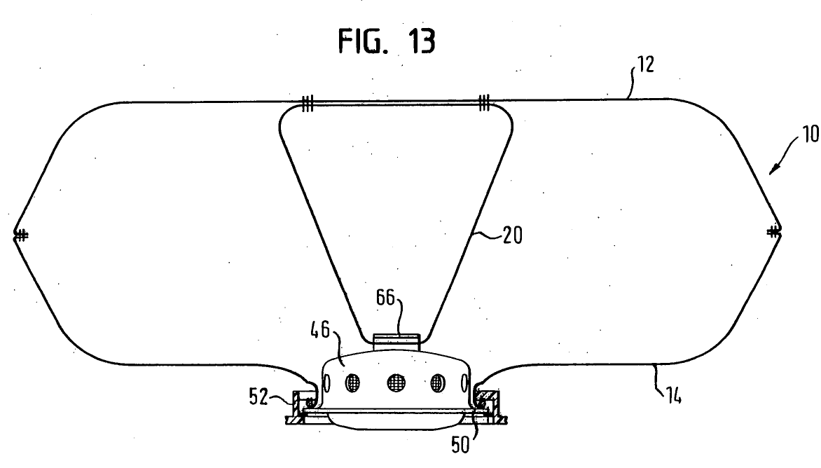

FIG. 13 shows an alternative possibility for arranging the limiting strap 20. In this case, the limiting strap 20 is not designed to have loose ends, but rather as a closed loop. The limiting strap 20 is suspended into a bracket 66, hook or the like arranged on or above the gas generator 46. The bracket 66 can be formed onto the gas generator 46 or be constructed in one piece therewith, or it may be fastened as a type of clip to the gas generator 46 or to the gas generator carrier 24. During the folding process, the limiting strap loop, which is shorter than the height of the gas bag 10 when pushed in to a maximum, can be held in the tubular folding device 32 e.g. by the partial vacuum, guided and, when the tubular folding device 32 is withdrawn, can also be brought outside again, in order to then be suspended on the bracket 66.

The steps as described for assembling the gas bag module are all suited for an automated assembly.

The methods as described for folding the gas bag 10 and for assembling the gas bag module can basically also be implemented without sucking air out of the gas bag 10 (after the axial displacement of the tubular folding device 32). In this case, the tubular folding device 32 may be constructed to be simpler (without bores) and does not have to be connected to a suction pump.

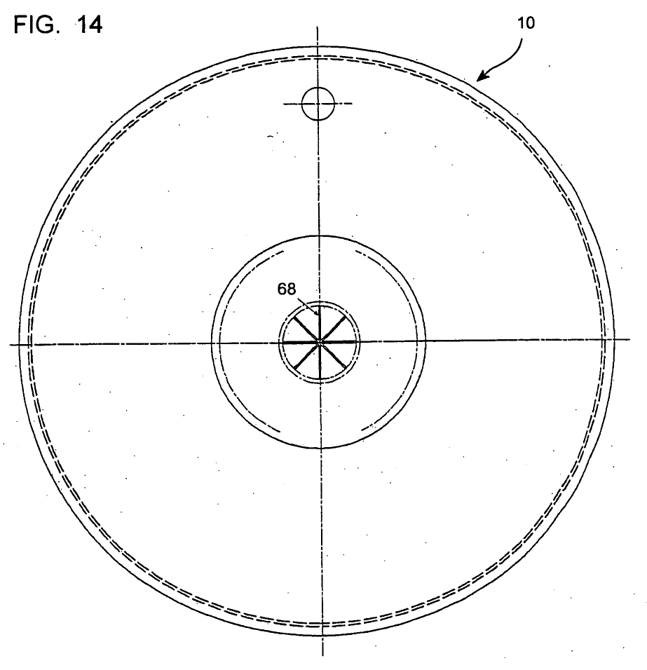

FIG. 14 shows a gas bag 10 which has a slit shaped inflation opening area 68 which is suitable in particular for a folding and an assembly which does not involve sucking out air.

1. A device for folding a gas bag, the device comprising a positioning means for the gas bag and an axially displaceable tubular folding device, the positioning means positioning the gas bag such that upon an axial movement of the tubular folding device, the gas bag is turned over the tubular folding device.

2. The device according to claim 1, wherein the gas bag is turned inside out by the tubular folding device.

3. The device according to claim 1, wherein the tubular folding device includes an outer tube having several bores, the tubular folding device being adapted to be connected to a suction pump.

4. The device according to claim 3, wherein the tubular folding device further includes an inner tube having several bores, the inner tube being movable, in particular rotatable and/or axially displaceable, relative to the outer tube.

5. The device according to claim 3, wherein one end of the tubular folding device is adapted to be closed by a controllable flap.

6. A method of folding a gas bag having an inflation opening, the method using a device according to claim 1 and comprising the following steps:
positioning the tubular folding device on the side of the gas bag opposite the inflation opening;
axially displacing the tubular folding device through the inflation opening, so that the gas bag is turned over the tubular folding device; and
withdrawing the tubular folding device from the inflation opening.

7. The method according to claim 6, wherein the axial displacement of the tubular device causes the gas bag to be turned inside out.

8. The method according to claim 6, wherein prior to withdrawal of the tubular folding device, air present in the gas bag is sucked out, in particular through the tubular folding device.

9. The method according to claim 7, wherein a device according to claim 3 is used, and wherein during sucking out the air and withdrawal of the tubular folding device, the inner tube is moved relative to the outer tube.

10. The method according to claim 7, wherein a device according to claim 4 is used, and wherein during sucking out the air and withdrawal of the tubular folding device the flap is actuated.

11. A method of assembling a gas bag module, comprising the step of folding a gas bag in accordance with the method as set forth in claim 6, the axial displacement of the tubular folding device causing the gas bag to be drawn through an opening into a mounting, preferably into a gas generator carrier.

12. The method according to claim 11, wherein in the region of the inflation opening, holes are provided which, before the axial displacement of the tubular folding device, are drawn over corresponding pins projecting on the mounting.

13. The method according to claim 12, wherein during the axial displacement of the tubular folding device, further holes, provided outside the holes, are likewise drawn over the pins.

14. The method according to claim 11, wherein at least one of the gas bag and a gas generator is fastened by means of a fastening ring.

15. The method according to claim 11, wherein the gas bag, with the tubular folding device not yet fully withdrawn, is pressed together in the direction of the opening.

16. The method according to claim 11, wherein a limiting strap is sewn onto the side of the gas bag opposite the inflation opening, the limiting strap having ends which are loose and are dimensioned to be so long that with the axial displacement of the tubular folding device they are not fully drawn through the opening.

17. The method according to claim 16, wherein the loose ends of the limiting strap projecting out of the opening are fastened to the gas bag module.

18. The method according to claim 17, wherein the mounting is a gas generator carrier and the loose ends of the limiting strap are fastened by clamping in a compound of the gas generator carrier and a covering cap placed onto the gas generator carrier.

19. The method according to claim 11, wherein a limiting strap in the form of a loop is sewn onto the gas bag and is suspended into a bracket or the like arranged on the gas bag module.

20. A gas bag module which is assembled in accordance with the method set forth in claim 11.

21. The gas bag module according to claim 20, wherein a gas bag is provided having a slit-shaped inflation opening area.
